(19) United States
(12) Patent Application Publication
(10) Pub. No.: US 2026/0343520 A1
(43) Pub. Date: Oct. 29, 2026

(54) APPLICATION OF A SCRAMBLING SEQUENCE TO UPLINK TRANSMISSIONS

(71) Applicant: QUALCOMM Incorporated, San Diego, CA (US)

(72) Inventors: Marwen ZORGUI, San Diego, CA (US); Mostafa KHOSHNEVISAN, San Diego, CA (US); Tao LUO, San Diego, CA (US)

(21) Appl. No.: 19/570,620

(22) Filed: Mar. 18, 2026

Related U.S. Application Data
(60) Provisional application No. 63/793,460, filed on Apr. 23, 2025.

(51) Int. Cl. H04W 72/044; H04W 72/21; H04W 72/232

(52) U.S. Cl. CPC H04W 72/0466; H04W 72/21; H04W 72/232

(57) ABSTRACT

Various aspects of the present disclosure generally relate to wireless communication. In some aspects, a user equipment (UE) may receive, from a network node, a downlink transmission that comprises information. The UE may generate a scrambling sequence to apply to an uplink transmission using the information comprised in the downlink transmission. The UE may transmit, to the network node, the uplink transmission in accordance with the scrambling sequence. Numerous other aspects are described.

### CROSS-REFERENCE TO RELATED APPLICATION

This Patent Application claims priority to U.S. Provisional Patent Application No. 63/793,460, filed on Apr. 23, 2025, entitled “APPLICATION OF A SCRAMBLING SEQUENCE TO LAYER 1 UPLINK TRANSMISSIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with application of a scrambling sequence to uplink transmissions.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be configured to receive, from a network node, a downlink transmission that comprises information. The one or more processors may be configured to generate a scrambling sequence to apply to a Layer 1 (L1) uplink transmission using the information comprised in the downlink transmission. The one or more processors may be configured to transmit, to the network node, the L1 uplink transmission in accordance with the scrambling sequence.

Some aspects described herein relate to a network node for wireless communication. The network node may include one or more memories and one or more processors coupled to the one or more memories. The one or more processors may be configured to transmit, to a UE, a downlink transmission that comprises information. The one or more processors may be configured to generate a scrambling sequence using the information comprised in the downlink transmission. The one or more processors may be configured to receive, from the UE, an L1 uplink transmission that is associated with the scrambling sequence. The one or more processors may be configured to decode the L1 uplink transmission in accordance with the scrambling sequence.

Some aspects described herein relate to a method of wireless communication performed by a UE. The method may include receiving, from a network node, a downlink transmission that comprises information. The method may include generating a scrambling sequence to apply to an L1 uplink transmission using the information comprised in the downlink transmission. The method may include transmitting, to the network node, the L1 uplink transmission in accordance with the scrambling sequence.

Some aspects described herein relate to a method of wireless communication performed by a network node. The method may include transmitting, to a UE, a downlink transmission that comprises information. The method may include generating a scrambling sequence using the information comprised in the downlink transmission. The method may include receiving, from the UE, an L1 uplink transmission that is associated with the scrambling sequence. The method may include decoding the L1 uplink transmission in accordance with the scrambling sequence.

Some aspects described herein relate to a non-transitory computer-readable medium that stores one or more instructions. The one or more instructions, when executed by one or more processors of a UE, cause the UE to receive, from a network node, a downlink transmission that comprises information. The one or more instructions, when executed by one or more processors of the UE, cause the UE to generate a scrambling sequence to apply to an L1 uplink transmission using the information comprised in the downlink transmission. The one or more instructions, when executed by one or more processors of the UE, cause the UE to transmit, to the network node, the L1 uplink transmission in accordance with the scrambling sequence.

Some aspects described herein relate to a non-transitory computer-readable medium that stores one or more instructions. The one or more instructions, when executed by one or more processors of a network node, cause the network node to transmit, to a UE, a downlink transmission that comprises information. The one or more instructions, when executed by one or more processors of the network node, cause the network node to generate a scrambling sequence using the information comprised in the downlink transmission. The one or more instructions, when executed by one or more processors of the network node, cause the network node to receive, from the UE, an L1 uplink transmission that is associated with the scrambling sequence. The one or more instructions, when executed by one or more processors of the network node, cause the network node to decode the L1 uplink transmission in accordance with the scrambling sequence.

Some aspects described herein relate to an apparatus for wireless communication. The apparatus may include means for receiving, from a network node, a downlink transmission that comprises information. The apparatus may include means for generating a scrambling sequence to apply to an L1 uplink transmission using the information comprised in the downlink transmission. The apparatus may include means for transmitting, to the network node, the L1 uplink transmission in accordance with the scrambling sequence.

Some aspects described herein relate to an apparatus for wireless communication. The apparatus may include means for transmitting, to a UE, a downlink transmission that comprises information. The apparatus may include means for generating a scrambling sequence using the information comprised in the downlink transmission. The apparatus may include means for receiving, from the UE, an L1 uplink transmission that is associated with the scrambling sequence. The apparatus may include means for decoding the L1 uplink transmission in accordance with the scrambling sequence.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of physical channels and reference signals in a wireless network.

FIG. 3 is a diagram of an example of wireless communications system with an aggressor network node.

FIG. 4 is a diagram of an example of applying a scrambling sequence to Layer 1 (L1) uplink transmissions.

FIG. 5 is a diagram illustrating an example associated with signaling that enables application of a scrambling sequence to L1 uplink transmissions.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

In wireless communication systems, radio access technologies (RATs), (such as global system for mobile communications (GSM), universal mobile telecommunications system (UMTS), Long-Term Evolution (LTE), and New Radio (NR)) offer security functionalities that include ciphering and integrity protection. These security measures are applied to both control plane and user plane data at the packet data convergence protocol (PDCP) layer, utilizing keys from the access security management entity (ASME). However, while unicast physical downlink shared channel (PDSCH) or physical uplink shared channel (PUSCH) transmissions are secure and encrypted, Layer 1 (L1) signaling, which includes downlink control information (DCI) and uplink control information (UCI), as well as uplink reference signal (UL-RS) transmissions (e.g., sounding reference signals (SRSs)), may be unsecured and unencrypted.

The lack of encryption for L1 signaling poses a risk because an attacker, such as a rogue network node (e.g., aggressor network node) who decodes UCIs or detects SRSs has the potential to gain sensitive information such as the location of a user equipment (UE). Moreover, aggressor network nodes could leverage this control information received from the UE to perform malicious activities, such as reducing data rates by sending deceptive signals that create inter-cell interference, which may be challenging for the network to detect. Specifically, if an attacker can determine the transmission parameters of UCI or SRS transmissions, they can decode the content or detect the presence of these signals, leading to the aforementioned security breaches. Additionally, persistent attackers, even without knowledge of the DCI content, may attempt to blindly decode UCI or detect SRS during likely transmission times. Accordingly, the lack of encryption for L1 signaling allows for potential exploitation.

Various aspects relate generally to enhancing the security of L1 uplink transmissions in wireless communication systems. Some aspects more specifically relate to a UE receiving a downlink transmission, from a network node, that includes information used to generate a scrambling sequence. This scrambling sequence may then be applied to an L1 uplink transmission, such as a UCI or a UL-RS, and transmitted back to the network node. In some examples, the scrambling sequence may be additionally based on a transmission time of the L1 uplink transmission.

In some aspects, the scrambling sequence may be derived from the content of a last decoded PDSCH message, either before or after decryption, increasing the complexity of potential unauthorized decoding. For aperiodic UCI transmissions or aperiodic UL-RS transmissions that are scheduled by DCI, the scrambling sequence may be a function of one or more parts of the DCI payload or a cyclic redundancy check (CRC) of the DCI, enhancing the unpredictability of the scrambling pattern. In some aspects, the UE may transmit back a portion of the DCI payload within the L1 uplink transmission, providing an additional layer of encryption. The scrambling sequence may be applied to the UCI transmission before encoding in the information bit domain or after encoding. Additionally, the demodulation reference signal (DMRS) sequence of the UCI transmission may also be scrambled, further obfuscating the transmission sequence. In some aspects, if the L1 uplink transmission is an SRS, the UE may use the scrambling sequence to select the resources for transmitting the SRS, reducing the ability of an aggressor network node to blindly detect the SRS.

Particular aspects of the subject matter described in this disclosure can be implemented to realize one or more of the following potential advantages. By utilizing information from previously decoded PDSCH or DCI payloads to securely scramble L1 uplink transmissions, the UE can enhance the security of the transmission, thereby conserving network resources that would otherwise be expended in responding to security breaches or interference issues. Furthermore, by dynamically altering the scrambling sequence with each transmission based on a time dimension (such as the slot, frame, or system frame number (SFN)) the scrambling sequence may be continuously varied, adding an additional technical barrier that prevents attackers from deciphering the scrambling sequence. In some aspects, defining one or more selection rules for selecting which PDSCH message is used to generate the scrambling sequence, particularly when multiple PDSCHs are decoded, ensures that the UE and the network node maintain synchronization and consistent operation, reducing the risk of decoding errors and improving the efficiency of the communication system. Therefore, the techniques described herein effectively leverage secure elements from downlink transmissions to enhance the security of uplink transmissions, thereby conserving processing and memory resources by mitigating potential security threats and ensuring the robustness and reliability of the communication system.

5G NR may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

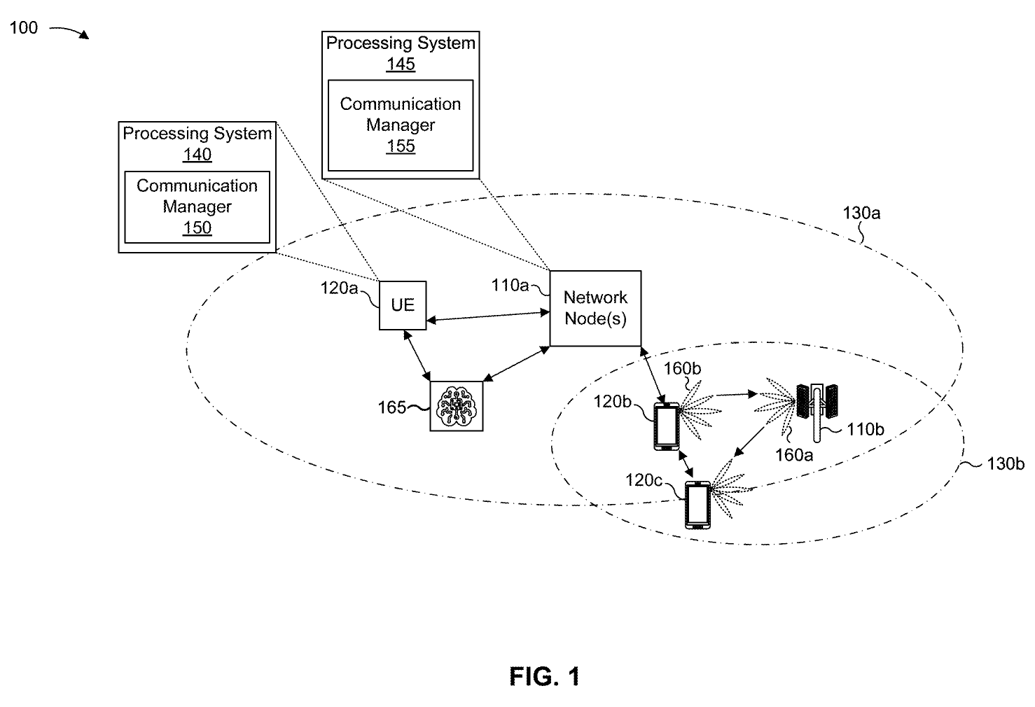

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410MHz through 7.125GHz), FR2 (24.25GHz through 52.6GHz), FR3 (7.125GHz through 24.25GHz), FR4a or FR4-1 (52.6GHz through 71GHz), FR4 (52.6GHz through 114.25GHz), and FR5 (114.25GHz through 300GHz). Although a portion of FR1 is greater than 6GHz, FR1 is often referred to (interchangeably) as a “sub-6GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a PDCP layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit UCI from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a network node, a downlink transmission that comprises information; generate a scrambling sequence to apply to an L1 uplink transmission using the information comprised in the downlink transmission; and transmit, to the network node, the L1 uplink transmission in accordance with the scrambling sequence. Additionally, or alternatively, the communication manager 150 may perform one or more other operations described herein.

In some aspects, the network node 110 may include a communication manager 155. As described in more detail elsewhere herein, the communication manager 155 may transmit, to a UE, a downlink transmission that comprises information; generate a scrambling sequence using the information comprised in the downlink transmission; and receive, from the UE, an L1 uplink transmission that is associated with the scrambling sequence; and decode the L1 uplink transmission in accordance with the scrambling sequence. Additionally, or alternatively, the communication manager 155 may perform one or more other operations described herein.

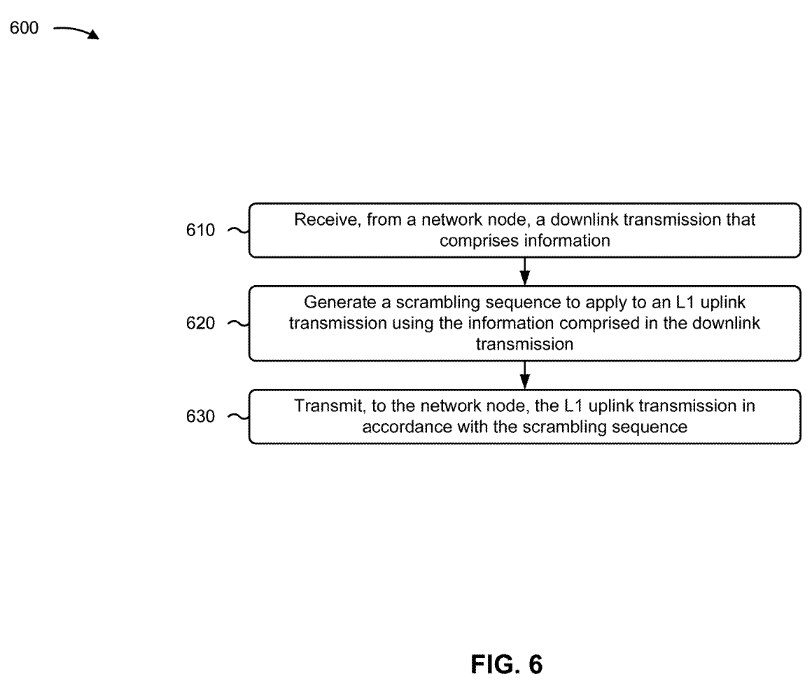

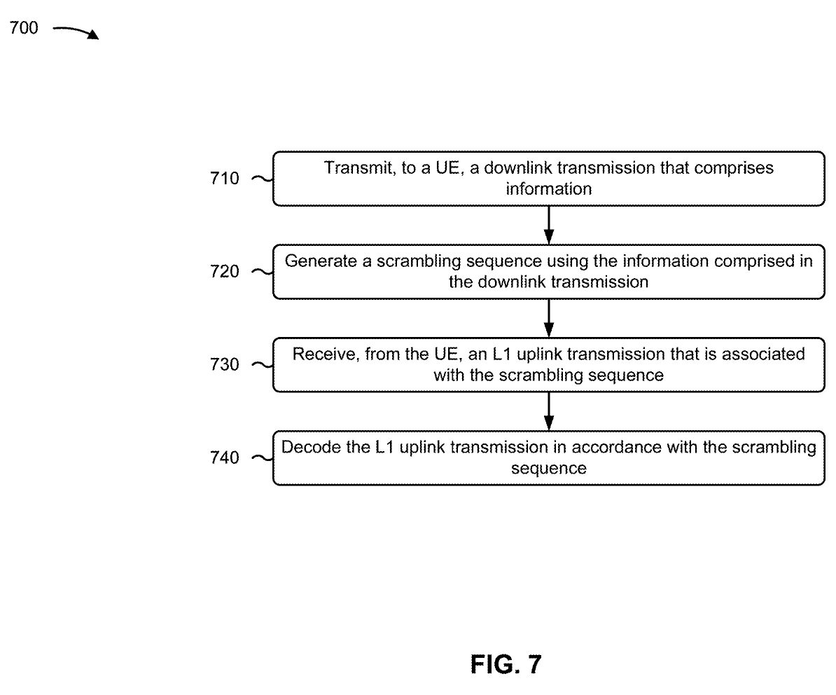

The network node 110, the processing system 145 of the network node 110, the UE 120, the processing system 140 of the UE 120, or any other component(s) of FIG. 1 may implement one or more techniques or perform one or more operations associated with application of a scrambling sequence to Layer 1 uplink transmissions, as described in more detail elsewhere herein. For example, the processing system 145 of the network node 110, or the processing system 140 of the UE 120 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

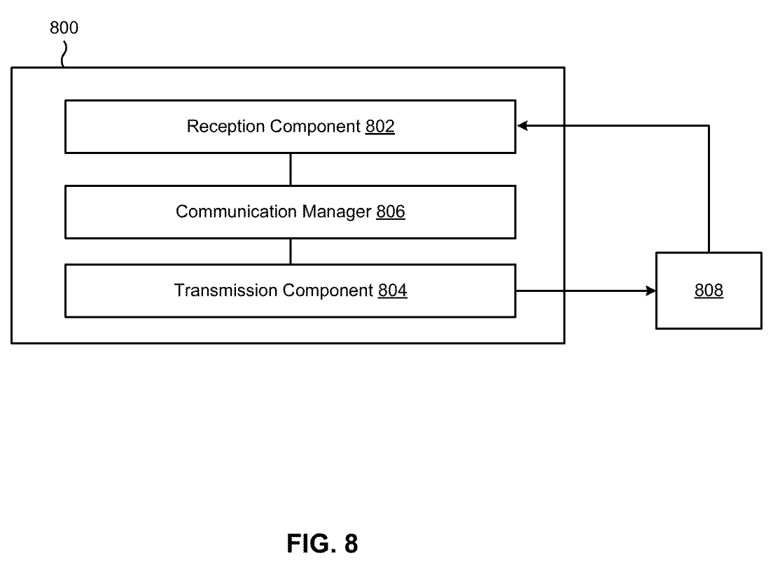

In some aspects, the UE 120 includes means for receiving, from a network node, a downlink transmission that comprises information; means for generating a scrambling sequence to apply to an L1 uplink transmission using the information comprised in the downlink transmission; or means for transmitting, to the network node, the L1 uplink transmission in accordance with the scrambling sequence. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

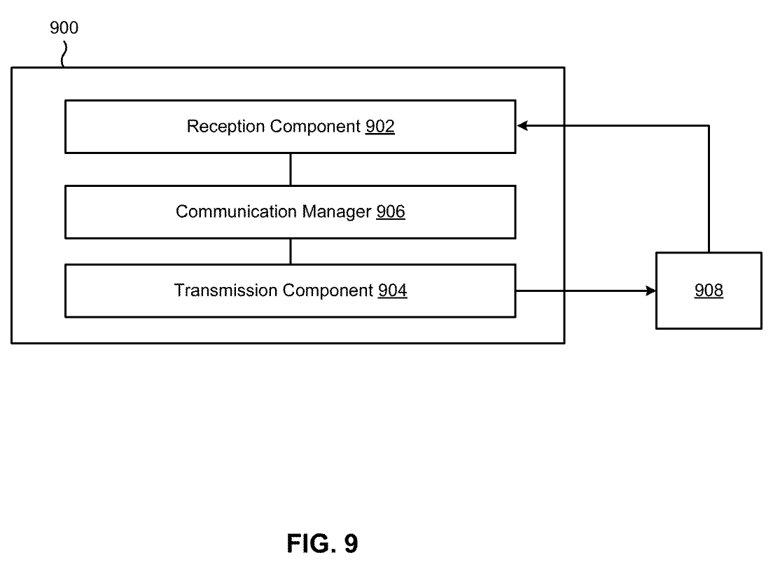

In some aspects, the network node 110 includes means for transmitting, to a UE, a downlink transmission that comprises information; means for generating a scrambling sequence using the information comprised in the downlink transmission; or means for receiving, from the UE, an L1 uplink transmission that is associated with the scrambling sequence; or means for decoding the L1 uplink transmission in accordance with the scrambling sequence. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples..

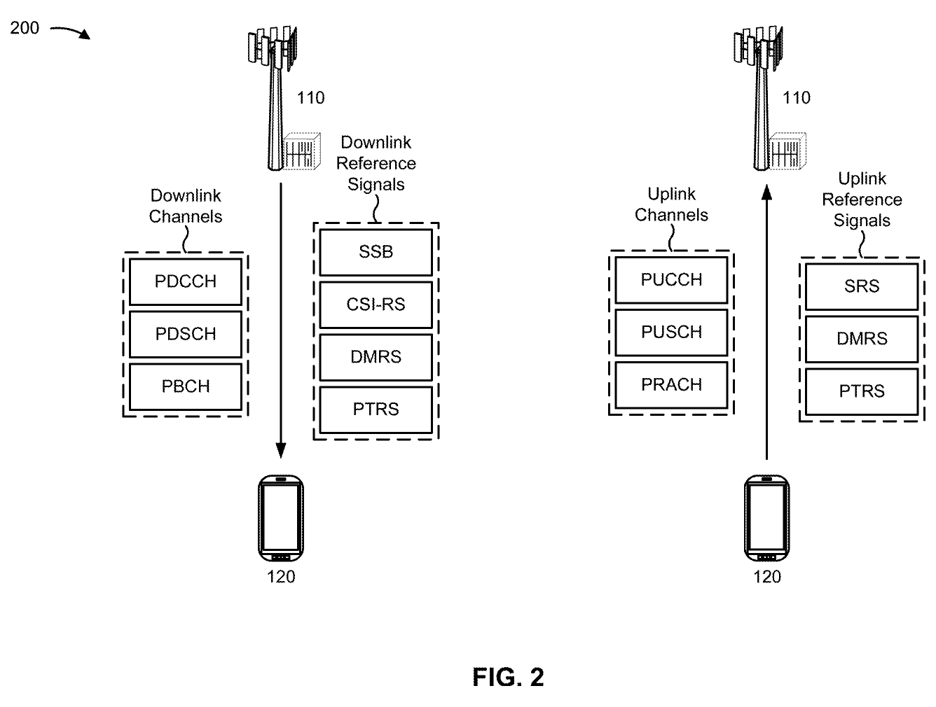

FIG. 2 is a diagram illustrating an example 200 of physical channels and reference signals in a wireless network. As shown in FIG. 2, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a PUCCH that carries UCI, a PUSCH that carries uplink data, or a physical random access channel (PRACH) used for initial network access, among other examples. In some aspects, the UE 120 may transmit ACK or NACK feedback (e.g., ACK/NACK feedback or ACK/NACK information) in UCI on the PUCCH or the PUSCH.

As further shown, a downlink reference signal may include a synchronization signal block (SSB), a CSI-RS, a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 2 is provided as an example. Other examples may differ from what is described with regard to FIG. 2.

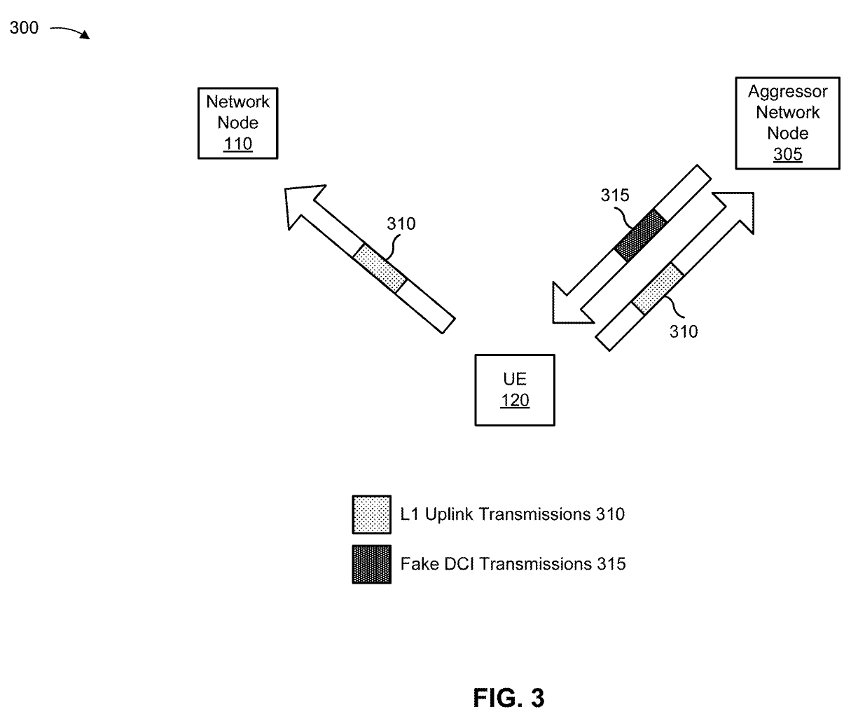

FIG. 3 is a diagram of an example 300 of wireless communications system with an aggressor network node 305. In some examples, FIG. 3 may implement one or more aspects of FIGS. 1 and 2. For example, FIG. 3 includes the UE 120 and the network node 110 described elsewhere herein. Additionally, FIG. 3 includes an aggressor network node 305, which may be an example a second network node 110.

In some examples, the example 300 may operate in accordance with one or more RATs (e.g., 3GPP RATs) that support security functionalities. For instance, 3GPP RATs such as GSM, UMTS, LTE, and NR include one or more security functionalities that ensure the confidentiality, integrity, and authenticity of communications within the network. These RATs support a range of security functionalities, including ciphering and integrity protection, which are applied to both the control plane and user plane data. For instance, ciphering may be used to encrypt data, making the data unintelligible to unauthorized parties, while integrity protection may ensure that the data has not been tampered with during transmission. In the control plane, security measures are applied to RRC signaling through signaling radio bearers (SRBs). The SRBs may ensure that the commands and control messages exchanged between the UE 120 and the network node 110 are secure and reliable. For user plane data, which includes the actual user data being transmitted, security may be applied through data radio bearers (DRBs) in the PDCP layer. This dual-layer approach ensures comprehensive protection for both signaling and user data. Additionally, or alternatively, the network node 110 and the UE 120 may operate in accordance with an ASME key. The ASME key may be derived during an authentication process and is used to generate further keys for ciphering and integrity protection. This hierarchical key management system ensures that even if one key is compromised, the overall security of the communication remains intact. By implementing these robust security measures, 3GPP RATs provide a secure environment for mobile communications, protecting user data and maintaining the integrity of the network.

As shown in FIG. 3, the UE 120 may transmit, and the network node 110 may receive, one or more L1 uplink transmissions 310. In wireless communication systems, the L1 uplink transmissions 310 may refer to the physical layer transmissions from the UE 120 to the network node 110. In some examples, the L1 uplink transmissions 310 may include UCI transmissions. UCI includes various types of feedback and control information that the UE 120 sends to the network node 110 to facilitate efficient communication and resource management. For instance, various examples of UCI include CSI reports and HARQ acknowledgment (HARQ-ACK) feedback. CSI reports provide the network node 110 with detailed information about the current state of the radio channel, including parameters like CQIs, PMIs, and RIs as described elsewhere herein. This information helps the network node 110 optimize resource allocation and adapt modulation and coding schemes to current channel conditions. Additionally, HARQ-ACK feedback, may be used to acknowledge the receipt of downlink data packets. When the UE 120 receives a data packet from the network node 110, the UE 120 may process the packet and send back an ACK if the packet is correctly received or a NACK if there are errors in receiving or decoding. Accordingly, HARQ feedback serves as a mechanism ensuring reliable data transmission and enabling retransmissions of erroneous packets.

Another example of L1 uplink transmissions 310 are various types of UL-RSs, which include SRSs and DMRSs, among other examples. For instance, SRSs are transmitted by the UE 120 to provide the network node 110 with information about the uplink channel quality across different frequencies. This channel quality information is used for tasks such as uplink channel estimation, frequency-selective scheduling, or link adaptation, among other examples. The UE 120 may transmit SRSs periodically, semi-persistently, or aperiodically and SRSs cover a wide frequency range, allowing the network node 110 to assess the channel conditions over the entire uplink bandwidth. Additionally, DMRSs are embedded within the data transmission and are used by the network node 110 to perform channel estimation for demodulating the uplink data. The network node 110 may use received DMRSs to perform coherent demodulation, as DMRSs enable the network node 110 to accurately estimate the channel impact on the transmitted signal, thereby improving the reliability and accuracy of data decoding. Accordingly, both SRS and DMRS assist in maintaining the quality and efficiency of uplink transmissions, ensuring that the network node 110 can effectively manage and optimize the uplink communication link.

In some examples, however, the aggressor network node 305 may attempt to interfere with communications between the UE 120 and the network node 110 by intercepting and receiving the L1 uplink transmissions 310 intended for the network node 110. For instance, while unicast PDSCH and PUSCH transmissions are typically secure and encrypted to protect user data, L1 signaling (such as DCI, UCI, and UL-RSs) are often not encrypted. This lack of encryption in L1 signaling poses a security vulnerability, especially in the presence of the aggressor network node 305. The aggressor network node 305 (which may be a malicious or rogue network node 110) can intercept and decode UCI transmissions, including CSI reports and HARQ-ACK feedback. By doing so, the aggressor network node 305 can gain insights into the communication parameters and channel conditions of the UE 120. For instance, CSI reports provide detailed information about the channel quality and conditions, while HARQ-ACK feedback indicates the success or failure of data packet transmissions. Additionally, or alternatively, by detecting SRSs, the aggressor network node 305 can infer the uplink channel quality across different frequencies of the uplink frequency bandwidth.

The ability of an aggressor network node 305 to intercept these L1 uplink transmissions 310 enables the aggressor node to perform malicious activities that can reduce the network performance and security. For instance, the aggressor network node 305 may infer sensitive information, such as the location of the UE 120, by analyzing the intercepted signals. This can lead to privacy breaches and unauthorized tracking of users. Furthermore, the aggressor can exploit the intercepted information to degrade the network performance. For example, by using the decoded UCI or detected SRS, the aggressor network node 305 can transmit fake DCI transmissions 315 to cell-edge UEs (e.g., including the UE 120), instructing the cell-edge UEs to transmit at specific times or frequencies that cause inter-cell interference. This interference can disrupt legitimate communications, leading to increased packet loss, higher latency, and reduced data rates. Such interference may be challenging for the network node 110 or for the UE 120 to detect because the fake DCI transmissions 315 mimic legitimate control signaling. Consequently, the quality of service between the UE 120 and the network node 110 may be degraded, and network reliability and efficiency may be compromised.

As indicated above, FIG. 3 is provided as an example. Other examples may differ from what is described with regard to FIG. 3.

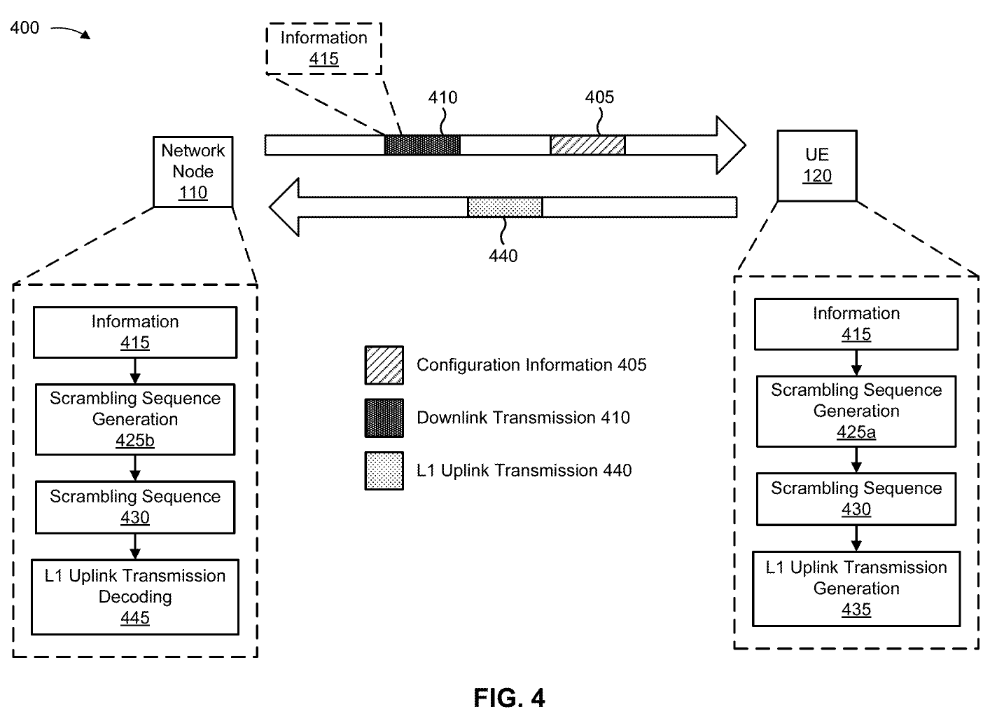

FIG. 4 is a diagram of an example 400 of applying a scrambling sequence 430 to L1 uplink transmissions. In some examples, FIG. 4 may implement one or more aspects of FIGS. 1-3. For example, FIG. 4 includes wireless communications between the UE 120 and the network node 110 described elsewhere herein. Additionally, FIG. 4 an L1 uplink transmission 440 which may be an example of the L1 uplink transmissions 310, as described with reference to FIG. 3.

As shown in FIG. 4, the network node 110 may transmit, and the UE 120 may receive, configuration information 405. In some examples, the configuration information 405 may be transmitted via one or more of system information (e.g., including master information block (MIB) or SIB), RRC signaling, MAC signaling (e.g., including one or more MAC-CEs), or DCI signaling. The configuration information 405 may include or indicate one or more parameters described herein that enables applying a scrambling sequence 430 to the L1 uplink transmission 440. Further description of the configuration information 405 described elsewhere.

As described with reference elsewhere herein, the aggressor network node 305 may attempt to obtain the transmission parameters of UCI or SRS transmissions. Accordingly, the UE 120 and network node 110 implement measures that increase difficulty at the aggressor network node 305 to decode the content of UCI or detect SRS. According to one or more techniques, the UE 120 may use some content (e.g., information 415) from a previously decoded valid PDSCH to scramble the UCI or determine the SRS sequence. This approach leverages the dynamic nature of the PDSCH content, thereby introducing an additional layer of complexity that the aggressor network node 305 must overcome. By incorporating elements of the most recently decoded PDSCH into the scrambling sequence 430 or SRS determination, the system ensures that the parameters used for UCI and SRS transmissions are less predictable and more resistant to interception or decoding by unauthorized entities. These techniques may be applicable to both periodic and aperiodic UCI and SRS transmissions, enhancing the overall security and integrity of the communication system.

Additionally, or alternatively, the aggressor network node 305 may persistently attempt to blindly decode UCI or detect SRS during likely occasions, despite not knowing the scheduling DCI content. Accordingly, for aperiodic UCI and SRS transmissions (which may be scheduled by the DCI), the UE 120 may use some content (e.g., the information 415) from the scheduling DCI payload to scramble the UCI or determine the SRS sequence. By incorporating elements of the DCI payload into the scrambling process or SRS sequence determination, the system introduces an additional layer of unpredictability. This approach ensures that even if the aggressor network node 305 can anticipate the timing of potential transmissions, the specific parameters used for UCI and SRS remain obscure and challenging to decode without access to the DCI content. Accordingly, such techniques enhance the security of aperiodic UCI and SRS transmissions by making intercepting or decoding more difficult for unauthorized entities.

In some examples, the L1 uplink transmission 440 may be a UCI transmission. For example, the UCI transmission may be a CSI report (e.g., aperiodic, semi-persistent, or periodic), a scheduling request (SR) transmission, or a HARQ-feedback transmission, among other examples. In some examples of the UCI transmission, the scrambling sequence 430 may be derived based on the content of the last (or most recent) PDSCH message decoded by the UE 120. That is, the downlink transmission 410 may be a PDSCH message. Additionally, the last decoded PDSCH may be considered a valid PDSCH, where “valid” may denote that the PDSCH is secure. This security may be ensured by the fact that the PDSCH message is a unicast encrypted PDSCH, and the encryption has been verified. The term “content” in the context of the PDSCH message may refer to a portion of the downlink transport block within the PDSCH. This portion can be taken either before or after a decryption process performed at the UE 120. In other words, the “content” of the PDSCH message may refer to the information 415 used by the UE 120 to generate the scrambling sequence 430. Accordingly, the information 415 used for further operations, such as scrambling the UCI transmission, can be a direct segment of the downlink transport block or a function derived from that segment, ensuring that the derived parameters are secure and resistant to unauthorized access or decoding.

In some examples, the UCI transmission may be an aperiodic UCI transmission that is scheduled by a DCI (e.g., a scheduling DCI). Aperiodic UCI transmissions, scheduled by a DCI, may include aperiodic CSI reports and HARQ-ACK feedback. Aperiodic CSI reports can be scheduled by an uplink or downlink grant and can be multiplexed on a PUSCH or transmitted on a PUCCH. Similarly, HARQ-ACK feedback can be scheduled by a downlink or uplink grant and can be transmitted on a PUCCH or multiplexed on a PUSCH. This flexible scheduling and transmission approach enhances resource utilization and system performance. Additionally, if the UCI transmission is an aperiodic UCI transmission, then the downlink transmission 410 may be the scheduling DCI that schedules the aperiodic UCI transmission. Accordingly, the information 415 used to generate the scrambling sequence 430 may include one or more portions of the scheduling DCI payload, the CRC of the scheduling DCI, or combination thereof.

In accordance with obtaining the information 415 from the downlink transmission 410 (e.g., the content from the PDSCH message or the portions of the scheduling DCI), the UE 120 may use the information 415 to perform a scrambling sequence generation 425a. For example, the UE 120 generates the scrambling sequence 430 by inputting the information 415 into a pseudo-random number generator (PRNG) based on a scrambling algorithm. In some examples, the scrambling algorithm may be indicated in the configuration information 405. In some examples, the scrambling algorithm may be pre-configured at the UE 120 (e.g., via an original equipment manufacturer (OEM) configuration) or defined in a wireless communications standard (such as 3GPP). In some examples, the scrambling sequence 430 can additionally be a function of time. For instance, the UE 120 may further modify the scrambling sequence 430 based on a time of the UCI transmission (e.g., the slot, frame, or SFN of the UCI transmission). In other words, the UE 120 may alter the scrambling sequence 430 according to a time interval for transmitting the of the UCI transmission, which could be defined by time slots, subframes, or other time-based units. This time-dependent variation adds an additional layer of security and robustness to the communication system, as time variation reduces the likelihood of successful interception or interference by unauthorized entities. By continuously changing the scrambling sequence 430, the system enhances the overall integrity and reliability of the transmitted signals.

After generating the scrambling sequence 430, the UE 120 may apply the scrambling sequence 430 with the data bits of the UCI transmission as part of an L1 uplink transmission generation 435. For example, as part of the L1 uplink transmission generation 435, the UE 120 may apply the scrambling sequence 430 to one or more bits of the UCI transmission using an exclusive OR (XOR) operation. In the XOR operation, each bit of the one or more bits is combined with the corresponding bit of the scrambling sequence 430 using the XOR logic, which outputs a “1” if the bits are different and a “0” if they are the same. This operation effectively randomizes the data bits, making the transmitted signal less predictable and more resistant to interference. In some examples, the UE 120 may apply the scrambling sequence 430 to the UCI transmission before encoding the UCI transmission (e.g., in the information bit domain). Applying the scrambling sequence 430 before encoding may include applying the scrambling sequence 430 to the CRC of the UCI transmission (e.g., the CRC of the UCI transmission is scrambled prior to encoding). In some examples, the UE 120 may apply the scrambling sequence 430 to the UCI transmission after encoding the UCI transmission (e.g., coded bits of the UCI transmission are scrambled). In some examples, the UE 120 may apply the scrambling sequence 430 a DMRS sequence of the UCI transmission (e.g., the PUCCH or PUSCH DMRS of the UCI transmission is scrambled). Additionally, if the UCI transmission is an aperiodic transmission, a portion of the UCI payload can include or indicate one or more portions of the scheduling DCI payload. For instance, the UCI payload may explicitly include one or more portions of the scheduling DCI payload or may include a set of bits that are based on the one or more portions of the scheduling DCI payload (e.g., serving as an echo of the scheduling DCI payload).

After performing the L1 uplink transmission generation 435, the UE 120 may transmit, and the network node 110 may receive, the UCI transmission (e.g., the L1 uplink transmission 440). In some examples, the network node 110 may additionally use the scrambling sequence 430 to descramble and decode the L1 uplink transmission 440. For example, the network node 110 may use the information 415 to perform a scrambling sequence generation 425b. In some examples, the scrambling sequence generation 425b may include the same operations performed in the scrambling sequence generation 425a but performed by the network node 110. Accordingly, the network node 110 may generate the scrambling sequence 430.

After generating the scrambling sequence 430, the network node 110 may perform L1 uplink transmission 440 decoding 445. For example, the network node 110 may use the same scrambling sequence 430 (used by the UE 120 to perform the XOR operation) and may perform another XOR operation to reverse the scrambling (e.g., descramble) the UCI transmission. This technique ensures that the transmission is secure and robust against errors introduced during the communication process.

In some examples, the L1 uplink transmission 440 may be a UL-RS transmission. For example, the UL-RS transmission may be an SRS transmission (e.g., aperiodic, semi-persistent, or periodic) or a DMRS transmission (e.g., a PUCCH DMRS or PUSCH DMRS), among other examples. In some examples of the UL-RS transmission, the scrambling sequence 430 may be derived based on the content of the last (or most recent) PDSCH message decoded by the UE 120. That is, the downlink transmission 410 may be a PDSCH message. Additionally, the last decoded PDSCH may be considered a valid PDSCH, where “valid” may denote that the PDSCH is secure. This security may be ensured by the fact that the PDSCH message is a unicast encrypted PDSCH, and the encryption has been verified. The term “content” in the context of the PDSCH message may refer to a portion of the downlink transport block within the PDSCH. This portion can be taken either before or after a decryption process performed at the UE 120. In other words, the “content” of the PDSCH message may refer to the information 415 used by the UE 120 to generate the scrambling sequence 430. Accordingly, the information 415 used for further operations, such as scrambling the UL-RS transmission, can be a direct segment of the downlink transport block or a function derived from that segment, ensuring that the derived parameters are secure and resistant to unauthorized access or decoding.

In some examples, the UL-RS transmission may be an aperiodic UL-RS transmission that is scheduled by a DCI (e.g., a scheduling DCI). Aperiodic UL-RS transmission, scheduled by a DCI, may include aperiodic SRS or aperiodic PUCCH or PUSCH with DMRS, among other examples, Additionally, if the UL-RS transmission is an aperiodic UL-RS transmission, then the downlink transmission 410 may be the scheduling DCI that schedules the aperiodic UL-RS transmission. Accordingly, the information 415 used to generate the scrambling sequence 430 may include one or more portions of the scheduling DCI payload, the CRC of the scheduling DCI, or combination thereof.

In accordance with obtaining the information 415 from the downlink transmission 410 (e.g., the content from the PDSCH message or the portions of the scheduling DCI), the UE 120 may use the information 415 to perform the scrambling sequence generation 425a. In some examples, the scrambling sequence 430 can additionally, be a function of time. For instance, the UE 120 may further modify the scrambling sequence 430 based on a time of the UL-RS transmission (e.g., the slot, frame, or SFN of the UCI transmission). In other words, the UE 120 may alter the scrambling sequence 430 according to a time interval for transmitting the UL-RS transmission, which could be defined by time slots, subframes, or other time-based units. This time-dependent variation adds an additional layer of security and robustness to the communication system, as time variation reduces the likelihood of successful interception or interference by unauthorized entities.

After generating the scrambling sequence 430, the UE 120 may apply the scrambling sequence 430 to the data bits of the UL-RS transmission as part of the L1 uplink transmission generation 435. For example, as part of the L1 uplink transmission generation 435, the UE 120 may apply the scrambling sequence 430 to one or more bits of the UL-RS transmission using the XOR operation.

In some other examples, as part of the L1 uplink transmission generation 435, the UE 120 may use the scrambling sequence 430 to select one or more parameters for transmission of the UL-RS transmission. For example, SRSs may be configured at the UE 120 through signaling from the network node 110 (e.g., the configuration information 405). The network node 110 provides the UE 120 with the configuration parameters that define how and when the SRS should be transmitted. These parameters include information about the frequency, time, and other aspects of the SRS transmission. The configuration of SRSs involves several parameters, such as SRS bandwidth configuration (e.g., specifies the bandwidth over which the SRS is transmitted), SRS periodicity and offset (e.g., defines the periodicity of how often the SRS is transmitted and the specific time instances when the SRS is transmitted), SRS sequence (e.g., indicates the specific sequence used for the SRS transmission, which can be based on a pseudo-random sequence), and SRS resource configuration (e.g., details the specific resources, such as frequency and time slots, allocated for the SRS transmission). Once these parameters are configured, the UE 120 can select from a set of predefined SRS resources for transmitting an SRS. According to the techniques described herein, the UE 120 may use the scrambling sequence 430 to select the SRS resources for transmitting an SRS from the set of predefined SRS resources. For instance, the set of predefined SRS resources may be indexed, where the scrambling sequence 430 indicates to the UE 120 one or more of the indexes to select the SRS resource from. Therefore, the scrambling sequence 430 may reduce the predictability of SRS resource selection by the UE 120, increasing difficulty at the aggressor network node 305 to monitor for UL-RSs, and therefore increase security for L1 communications between the UE 120 and network node 110.

After performing the L1 uplink transmission generation 435, the UE 120 may transmit, and the network node 110 may receive, the UL-RS transmission (e.g., the L1 uplink transmission 440). In some examples, the network node 110 may additionally use the scrambling sequence 430 to descramble and decode the L1 uplink transmission 440. For example, the network node 110 may use the information 415 to perform the scrambling sequence generation 425b.

After generating the scrambling sequence 430, the network node 110 may perform L1 uplink transmission 440 decoding 445. In some examples, the network node 110 may use the same scrambling sequence 430 (used by the UE 120 to perform the XOR operation) and may perform another XOR operation to reverse the scrambling (e.g., descramble) the UL-RS transmission. In some examples, the network node 110 may use the same scrambling sequence 430 to identify the set of SRS resources to monitor for and receive an SRS transmission. This technique ensures that the transmission is secure and robust against errors introduced during the communication process.

In examples where the downlink transmission 410 is a PDSCH message, the network node 110 and the UE 120 may use one or more techniques to ensure that both the network node 110 and the UE 120 use the same information 415 to perform the scrambling sequence generation 425a and 425b. For example, the UE 120 and the network node 110 may operate in accordance with one or more selection rules to determine valid PDSCH message to be used in encoding and decoding the L1 uplink transmission 440. In some examples, the configuration information 405 may indicate the one or more selection rules. Which rule of the one or more rules to follow may be defined in the wireless communications standard (such as 3GPP) or configured to the UE 120 through broadcast or UE-dedicated signaling.

In some examples, the one or more selection rules may indicate that the valid PDSCH message is the PDSCH for which the L1 uplink transmission 440 (e.g., a UCI) is carrying a HARQ feedback for. In some examples, the one or more selection rules may indicate that the valid PDSCH message is a most recent PDSCH (e.g., the last PDSCH) that the UE 120 sent an ACK message for (e.g., ignoring ACK-to-NACK error).

In cases of multi-component carrier communications (e.g., where multiple PDSCH messages may be transmitted concurrently), the one or more selection rules may be used to disambiguate which PDSCH message of multiple PDSCH messages to use for generating the scrambling sequence 430. In some examples, the one or more selection rules may indicate that the valid PDSCH message is the lowest or highest component carrier index for which HARQ feedback is being carried.

In some examples, the L1 uplink transmission 440 may be an example of multi-PDSCH HARQ feedback. For example, of multi-PDSCH HARQ feedback refers to the process where the UE 120 provides acknowledgment for multiple PDSCH transmissions within a single HARQ feedback message. In such examples, the HARQ feedback message from the UE 120 includes a separate feedback bit for each PDSCH transmission, indicating whether each PDSCH was successfully received (e.g., ACK) or if a retransmission is requested (e.g., NACK). Accordingly, the one or more selection rules may indicate that the valid PDSCH message is the PDSCH message corresponding to the first or last feedback bit included in the multi-PDSCH HARQ feedback.

As indicated above, FIG. 4 is provided as an example. Other examples may differ from what is described with regard to FIG. 4.

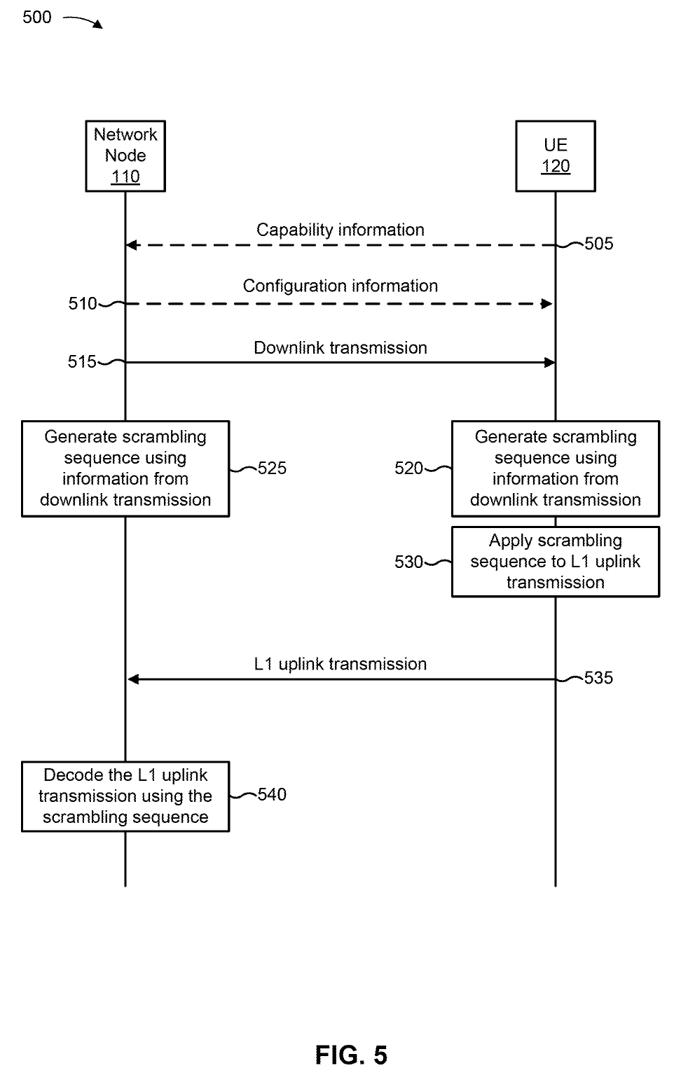

FIG. 5 is a diagram illustrating an example 500 associated with signaling that enables application of a scrambling sequence to L1 uplink transmissions. Example 500 may implement or be implemented by one or more aspects of FIGS. 1-4. For instance, example 500 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 500 shows operations between the UE 120 and the network node 110, the communication may occur between any number of network devices of various types described herein.

In a first operation 505, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter that the UE 120 supports generating a scrambling sequence to apply to one or more L1 uplink transmissions. In other words, the capability information may indicate that the UE 120 is capable of performing the scrambling sequence generation 425a and the L1 uplink transmission generation 435. One or more operations described herein may be based on the capability information. For example, the UE 120 may perform one or more operations of example 500 in accordance with the capability information or may receive one or more of configuration information or control information that is in accordance with the capability information. The network node 110 may determine configuration information for the UE 120 based on the capability information.

In a second operation 510, the network node 110 may transmit, and the UE 120 may receive, the configuration information. In some aspects, the UE 120 may receive the configuration information via one or more of system information signaling (e.g., a MIB or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an OEM configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate one or more selection rules for selection of a PDSCH transmission to use for generating the scrambling sequence, as described elsewhere herein. In some examples, the configuration information may be an example of the configuration information 405.

In a third operation 515, the network node 110 may transmit, and the UE 120 may receive, a downlink transmission that includes information (e.g., the information 415). In some examples, the downlink transmission may be the downlink transmission 410 (e.g., a PDSCH message or a scheduling DCI).

If the downlink transmission is a PDSCH transmission, then the UE 120 may use the one or more selection rules to identify to use the PDSCH transmission for generating the scrambling sequence. In some examples, the one or more selection rules indicate to select the PDSCH transmission based on the L1 uplink transmission including HARQ feedback for the PDSCH transmission. In some examples, the one or more selection rules indicate to select the PDSCH transmission based on previously transmitting an ACK message for the PDSCH transmission.

In a fourth operation 520, the UE 120 may generate a scrambling sequence (e.g., the scrambling sequence 430) to apply to an L1 uplink transmission (e.g., L1 uplink transmission 440) using the information included in the downlink transmission. For example, the UE 120 may perform the scrambling sequence generation 425a. As described elsewhere herein, the scrambling sequence may be further based on a time of transmission of the L1 uplink transmission.

In a fifth operation 525, the network node 110 may generate the scrambling sequence using the information included in the downlink transmission. For example, the UE 120 may perform the scrambling sequence generation 425b.

In a sixth operation 530, the UE 120 may apply the scrambling sequence to the L1 uplink transmission (e.g., as part of the L1 uplink transmission generation 435).

In some cases, the L1 uplink transmission is UCI transmission. In a first example, the downlink transmission may be a PDSCH message that was most recently decoded by the UE 120, and the information used to generate the scrambling sequence is a portion of a payload of the PDSCH message before decryption of the PDSCH message or after decryption of the PDSCH message. In a second example, the UCI transmission may be an aperiodic UCI transmission and the downlink transmission may be DCI transmission that schedules the aperiodic UCI transmission, and the scrambling sequence may a function of one or more of a payload of the DCI transmission or a CRC of the DCI transmission. In some examples, the aperiodic UCI transmission include at least a portion of the payload of the DCI transmission. In some examples, the scrambling sequence scrambles the UCI transmission before the UCI transmission is encoded. In some examples, the scrambling sequence scrambles the UCI transmission after the UCI transmission is encoded. In some examples, the scrambling sequence scrambles a DMRS of the UCI transmission.

In some cases, the L1 uplink transmission may be a UL-RS transmission. In a first example, the downlink transmission may be a PDSCH message that was most recently decoded by the UE 120, and the information used to generate the scrambling sequence is a portion of a payload of the PDSCH message before decryption of the PDSCH message or after decryption of the PDSCH message. In a second example, the UL-RS transmission may be an aperiodic UL-RS transmission and the downlink transmission is a DCI transmission that schedules the aperiodic UL-RS transmission, and the scrambling sequence may be a function of one or more of a payload of the DCI transmission or a CRC of the DCI transmission. In some examples, the UL-RS transmission is an SRS and the scrambling sequence is used to select the SRS from a set of SRSs. In some examples, the UL-RS transmission is an SRS and the scrambling sequence scrambles the SRS. In some examples, the UL-RS transmission is a DMRS transmission, and the scrambling sequence scrambles the DMRS transmission.

In a seventh operation 535, the UE 120 may transmit, and the network node 110 may receive, the L1 uplink transmission in accordance with the scrambling sequence.

In an eighth operation 540, the network node 110 may decode the L1 uplink transmission in accordance with the scrambling sequence. For example, the network node 110 may perform L1 uplink transmission decoding 445.

As indicated above, FIG. 5 is provided as an example. Other examples may differ from what is described with regard to FIG. 5.

FIG. 6 is a diagram illustrating an example process 600 performed, for example, at a UE or an apparatus of a UE. Example process 600 is an example where the apparatus or the UE (e.g., UE 120) performs operations associated with scrambling sequence applied to layer 1 uplink transmissions.

As shown in FIG. 6, in some aspects, process 600 may include receiving, from a network node, a downlink transmission that comprises information (block 610). For example, the UE (e.g., using reception component 802 or communication manager 806, depicted in FIG. 8) may receive, from a network node, a downlink transmission that comprises information, as described above.

As further shown in FIG. 6, in some aspects, process 600 may include generating a scrambling sequence to apply to an L1 uplink transmission using the information comprised in the downlink transmission (block 620). For example, the UE (e.g., using communication manager 806, depicted in FIG. 8) may generate a scrambling sequence to apply to an L1 uplink transmission using the information comprised in the downlink transmission, as described above.

As further shown in FIG. 6, in some aspects, process 600 may include transmitting, to the network node, the L1 uplink transmission in accordance with the scrambling sequence (block 630). For example, the UE (e.g., using transmission component 804 or communication manager 806, depicted in FIG. 8) may transmit, to the network node, the L1 uplink transmission in accordance with the scrambling sequence, as described above.

Process 600 may include additional aspects, such as any single aspect or any combination of aspects described below or in connection with one or more other processes described elsewhere herein.

In a first aspect, the L1 uplink transmission is a UCI transmission.

In a second aspect, alone or in combination with the first aspect, the downlink transmission is a PDSCH message that was most recently decoded by the UE, and the information used to generate the scrambling sequence is a portion of a payload of the PDSCH message before decryption of the PDSCH message or after decryption of the PDSCH message.

In a third aspect, alone or in combination with one or more of the first and second aspects, the UCI transmission is an aperiodic UCI transmission and the downlink transmission is a DCI transmission that schedules the aperiodic UCI transmission, and the scrambling sequence is a function of one or more of a payload of the DCI transmission or a CRC of the DCI transmission.

In a fourth aspect, alone or in combination with one or more of the first through third aspects, the aperiodic UCI transmission includes at least a portion of the payload of the DCI transmission.

In a fifth aspect, alone or in combination with one or more of the first through fourth aspects, the scrambling sequence scrambles the UCI transmission before the UCI transmission is encoded.

In a sixth aspect, alone or in combination with one or more of the first through fifth aspects, the scrambling sequence scrambles the UCI transmission after the UCI transmission is encoded.

In a seventh aspect, alone or in combination with one or more of the first through sixth aspects, the scrambling sequence scrambles a demodulation reference signal sequence of the UCI transmission.

In an eighth aspect, alone or in combination with one or more of the first through seventh aspects, the L1 uplink transmission is a UL-RS transmission.

In a ninth aspect, alone or in combination with one or more of the first through eighth aspects, the downlink transmission is a PDSCH message that was most recently decoded by the UE, and the information used to generate the scrambling sequence is a portion of a payload of the PDSCH message before decryption of the PDSCH message or after decryption of the PDSCH message.

In a tenth aspect, alone or in combination with one or more of the first through ninth aspects, the UL-RS transmission is an aperiodic UL-RS transmission and the downlink transmission is a DCI transmission that schedules the aperiodic UL-RS transmission, and the scrambling sequence is a function of one or more of a payload of the DCI transmission or a CRC of the DCI transmission.

In an eleventh aspect, alone or in combination with one or more of the first through tenth aspects, the UL-RS transmission is an SRS, and the scrambling sequence is used to select the SRS from a set of SRSs.

In a twelfth aspect, alone or in combination with one or more of the first through eleventh aspects, the UL-RS transmission is an SRS, and the scrambling sequence scrambles the SRS.

In a thirteenth aspect, alone or in combination with one or more of the first through twelfth aspects, the UL-RS transmission is a DMRS transmission, and the scrambling sequence scrambles the DMRS transmission.

In a fourteenth aspect, alone or in combination with one or more of the first through thirteenth aspects, generating the scrambling sequence is further based at least in part on a time of transmission of the L1 uplink transmission.

In a fifteenth aspect, alone or in combination with one or more of the first through fourteenth aspects, the downlink transmission is a PDSCH transmission, and the PDSCH transmission is selected to generate the scrambling sequence based at least in part on one or more selection rules.

In a sixteenth aspect, alone or in combination with one or more of the first through fifteenth aspects, the one or more selection rules indicate to select the PDSCH transmission based at least in part on the L1 uplink transmission including HARQ feedback for the PDSCH transmission.

In a seventeenth aspect, alone or in combination with one or more of the first through sixteenth aspects, the one or more selection rules indicate to select the PDSCH transmission based at least in part on previously transmitting an acknowledgment message for the PDSCH transmission.

In an eighteenth aspect, alone or in combination with one or more of the first through seventeenth aspects, process 600 includes receiving, from the network node, configuration information that indicates the one or more selection rules.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with scrambling sequence applied to layer 1 uplink transmissions.

As shown in FIG. 7, in some aspects, process 700 may include transmitting, to a UE, a downlink transmission that comprises information (block 710). For example, the network node (e.g., using transmission component 904 or communication manager 906, depicted in FIG. 9) may transmit, to a UE, a downlink transmission that comprises information, as described above.

As further shown in FIG. 7, in some aspects, process 700 may include generating a scrambling sequence using the information comprised in the downlink transmission (block 720). For example, the network node (e.g., using communication manager 906, depicted in FIG. 9) may generate a scrambling sequence using the information comprised in the downlink transmission, as described above.

As further shown in FIG. 7, in some aspects, process 700 may include receiving, from the UE, an L1 uplink transmission that is associated with the scrambling sequence (block 730). For example, the network node (e.g., using reception component 902 or communication manager 906, depicted in FIG. 9) may receive, from the UE, an L1 uplink transmission that is associated with the scrambling sequence, as described above.

As further shown in FIG. 7, in some aspects, process 700 may include decoding the L1 uplink transmission in accordance with the scrambling sequence (block 740). For example, the network node (e.g., using communication manager 906, depicted in FIG. 9) may decode the L1 uplink transmission in accordance with the scrambling sequence, as described above.

Process 700 may include additional aspects, such as any single aspect or any combination of aspects described below or in connection with one or more other processes described elsewhere herein.

In a first aspect, the L1 uplink transmission is a UCI transmission.

In a second aspect, alone or in combination with the first aspect, the downlink transmission is a PDSCH message that was most recently decoded by the UE, and the information used to generate the scrambling sequence is a portion of a payload of the PDSCH message before decryption of the PDSCH message or after decryption of the PDSCH message.

In a third aspect, alone or in combination with one or more of the first and second aspects, the UCI transmission is an aperiodic UCI transmission and the downlink transmission is a DCI transmission that schedules the aperiodic UCI transmission, and the scrambling sequence is a function of one or more of a payload of the DCI transmission or a CRC of the DCI transmission.

In a fourth aspect, alone or in combination with one or more of the first through third aspects, the aperiodic UCI transmission includes at least a portion of the payload of the DCI transmission.

In a fifth aspect, alone or in combination with one or more of the first through fourth aspects, the scrambling sequence scrambles the UCI transmission before the UCI transmission is encoded.

In a sixth aspect, alone or in combination with one or more of the first through fifth aspects, the scrambling sequence scrambles to the UCI transmission after the UCI transmission is encoded.

In a seventh aspect, alone or in combination with one or more of the first through sixth aspects, the scrambling sequence scrambles a demodulation reference signal sequence of the UCI transmission.

In an eighth aspect, alone or in combination with one or more of the first through seventh aspects, the L1 uplink transmission is a UL-RS transmission.

In a ninth aspect, alone or in combination with one or more of the first through eighth aspects, the downlink transmission is a PDSCH message that was most recently decoded by the UE, and the information used to generate the scrambling sequence is a portion of a payload of the PDSCH message before decryption of the PDSCH message or after decryption of the PDSCH message.

In a tenth aspect, alone or in combination with one or more of the first through ninth aspects, the UL-RS transmission is an aperiodic UL-RS transmission and the downlink transmission is a DCI transmission that schedules the aperiodic UL-RS transmission, and the scrambling sequence is a function of one or more of a payload of the DCI transmission or a CRC of the DCI transmission.

In an eleventh aspect, alone or in combination with one or more of the first through tenth aspects, the UL-RS transmission is an SRS, and the scrambling sequence is used to select the SRS from a set of SRSs.

In a twelfth aspect, alone or in combination with one or more of the first through eleventh aspects, the UL-RS transmission is an SRS, and the scrambling sequence scrambles the SRS.

In a thirteenth aspect, alone or in combination with one or more of the first through twelfth aspects, the UL-RS transmission is a DMRS transmission, and the scrambling sequence scrambles the DMRS transmission.

In a fourteenth aspect, alone or in combination with one or more of the first through thirteenth aspects, generating the scrambling sequence is further based at least in part on a time of transmission of the L1 uplink transmission.

In a fifteenth aspect, alone or in combination with one or more of the first through fourteenth aspects, the downlink transmission is a PDSCH transmission, and the PDSCH transmission is selected to generate the scrambling sequence based at least in part on one or more selection rules.

In a sixteenth aspect, alone or in combination with one or more of the first through fifteenth aspects, the one or more selection rules indicate to select the PDSCH transmission based at least in part on the L1 uplink transmission including HARQ feedback for the PDSCH transmission.

In a seventeenth aspect, alone or in combination with one or more of the first through sixteenth aspects, the one or more selection rules indicate to select the PDSCH transmission based at least in part on previously transmitting an acknowledgment message for the PDSCH transmission.

In an eighteenth aspect, alone or in combination with one or more of the first through seventeenth aspects, process 700 includes transmitting, from the network node, configuration information that indicates the one or more selection rules.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 2-5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, from a network node, a downlink transmission that comprises information. The communication manager 806 may generate a scrambling sequence to apply to an L1 uplink transmission using the information comprised in the downlink transmission. The transmission component 804 may transmit, to the network node, the L1 uplink transmission in accordance with the scrambling sequence.

The reception component 802 may receive, from the network node, configuration information that indicates the one or more selection rules, where the downlink transmission is selected to generate the scrambling sequence based at least in part on the one or more selection rules.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 2-5. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, a downlink transmission that comprises information. The communication manager 906 may generate a scrambling sequence using the information comprised in the downlink transmission. The reception component 902 may receive, from the UE, an L1 uplink transmission that is associated with the scrambling sequence. The communication manager 906 may decode the L1 uplink transmission in accordance with the scrambling sequence.

The transmission component 904 may transmit, from the network node, configuration information that indicates one or more selection rules.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving, from a network node, a downlink transmission that comprises information; generating a scrambling sequence to apply to a Layer 1 (L1) uplink transmission using the information comprised in the downlink transmission; and transmitting, to the network node, the L1 uplink transmission in accordance with the scrambling sequence.

Aspect 2: The method of Aspect 1, wherein the L1 uplink transmission is an uplink control information (UCI) transmission.

Aspect 3: The method of Aspect 2, wherein the downlink transmission is a physical downlink shared channel (PDSCH) message that was most recently decoded by the UE, and wherein the information used to generate the scrambling sequence is a portion of a payload of the PDSCH message before decryption of the PDSCH message or after decryption of the PDSCH message.

Aspect 4: The method of Aspect 2, wherein the UCI transmission is an aperiodic UCI transmission and the downlink transmission is a downlink control information (DCI) transmission that schedules the aperiodic UCI transmission, and wherein the scrambling sequence is a function of one or more of a payload of the DCI transmission or a CRC of the DCI transmission.

Aspect 5: The method of Aspect 4, wherein the aperiodic UCI transmission includes at least a portion of the payload of the DCI transmission.

Aspect 6: The method of Aspect 2, wherein the scrambling sequence scrambles the UCI transmission before the UCI transmission is encoded.

Aspect 7: The method of Aspect 2, wherein the scrambling sequence scrambles the UCI transmission after the UCI transmission is encoded.

Aspect 8: The method of Aspect 2, wherein the scrambling sequence scrambles a demodulation reference signal sequence of the UCI transmission.

Aspect 9: The method of any of Aspects 1-8, wherein the L1 uplink transmission is an uplink reference signal (UL-RS) transmission.

Aspect 10: The method of Aspect 9, wherein the downlink transmission is a physical downlink shared channel (PDSCH) message that was most recently decoded by the UE, and wherein the information used to generate the scrambling sequence is a portion of a payload of the PDSCH message before decryption of the PDSCH message or after decryption of the PDSCH message.

Aspect 11: The method of Aspect 9, wherein the UL-RS transmission is an aperiodic UL-RS transmission and the downlink transmission is a downlink control information (DCI) transmission that schedules the aperiodic UL-RS transmission, and wherein the scrambling sequence is a function of one or more of a payload of the DCI transmission or a CRC of the DCI transmission.

Aspect 12: The method of Aspect 9, wherein the UL-RS transmission is a sounding reference signal (SRS), and wherein the scrambling sequence is used to select the SRS from a set of SRSs.

Aspect 13: The method of Aspect 9, wherein the UL-RS transmission is a sounding reference signal (SRS), and wherein the scrambling sequence scrambles the SRS.

Aspect 14: The method of Aspect 9, wherein the UL-RS transmission is a demodulation reference signal (DMRS) transmission, and wherein the scrambling sequence scrambles the DMRS transmission.

Aspect 15: The method of any of Aspects 1-14, wherein generating the scrambling sequence is further based at least in part on a time of transmission of the L1 uplink transmission.

Aspect 16: The method of any of Aspects 1-15, wherein the downlink transmission is a physical downlink shared channel (PDSCH) transmission, and wherein the PDSCH transmission is selected to generate a scrambling sequence based at least in part one or more selection rules.

Aspect 17: The method of Aspect 16, wherein the one or more selection rules indicate to select the PDSCH transmission based at least in part on the L1 uplink transmission including HARQ feedback for the PDSCH transmission.

Aspect 18: The method of Aspect 16, wherein the one or more selection rules indicate to select the PDSCH transmission based at least in part on previously transmitting an acknowledgment message for the PDSCH transmission.

Aspect 19: The method of Aspect 16, further comprising: receiving, from the network node, configuration information that indicates the one or more selection rules.

Aspect 20: A method of wireless communication performed by a network node, comprising: transmitting, to a user equipment (UE), a downlink transmission that comprises information; generating a scrambling sequence using the information comprised in the downlink transmission; and receiving, from the UE, a Layer 1 (L1) uplink transmission that is associated with the scrambling sequence; and decoding the L1 uplink transmission in accordance with the scrambling sequence.

Aspect 21: The method of Aspect 20, wherein the L1 uplink transmission is an uplink control information (UCI) transmission.

Aspect 22: The method of Aspect 21, wherein the downlink transmission is a physical downlink shared channel (PDSCH) message that was most recently decoded by the UE, and wherein the information used to generate the scrambling sequence is a portion of a payload of the PDSCH message before decryption of the PDSCH message or after decryption of the PDSCH message.

Aspect 23: The method of Aspect 21, wherein the UCI transmission is an aperiodic UCI transmission and the downlink transmission is a downlink control information (DCI) transmission that schedules the aperiodic UCI transmission, and wherein the scrambling sequence is a function of one or more of a payload of the DCI transmission or a CRC of the DCI transmission.

Aspect 24: The method of Aspect 23, wherein the aperiodic UCI transmission includes at least a portion of the payload of the DCI transmission.

Aspect 25: The method of Aspect 21, wherein the scrambling sequence scrambles the UCI transmission before the UCI transmission is encoded.

Aspect 26: The method of Aspect 21, wherein the scrambling sequence scrambles to the UCI transmission after the UCI transmission is encoded.

Aspect 27: The method of Aspect 21, wherein the scrambling sequence scrambles a demodulation reference signal sequence of the UCI transmission.

Aspect 28: The method of any of Aspects 20-27, wherein the L1 uplink transmission is an uplink reference signal (UL-RS) transmission.

Aspect 29: The method of Aspect 28, wherein the downlink transmission is a physical downlink shared channel (PDSCH) message that was most recently decoded by the UE, and wherein the information used to generate the scrambling sequence is a portion of a payload of the PDSCH message before decryption of the PDSCH message or after decryption of the PDSCH message.

Aspect 30: The method of Aspect 28, wherein the UL-RS transmission is an aperiodic UL-RS transmission and the downlink transmission is a downlink control information (DCI) transmission that schedules the aperiodic UL-RS transmission, and wherein the scrambling sequence is a function of one or more of a payload of the DCI transmission or a CRC of the DCI transmission.

Aspect 31: The method of Aspect 28, wherein the UL-RS transmission is a sounding reference signal (SRS), and wherein the scrambling sequence is used to select the SRS from a set of SRSs.

Aspect 32: The method of Aspect 28, wherein the UL-RS transmission is a sounding reference signal (SRS), and wherein the scrambling sequence scrambles the SRS.

Aspect 33: The method of Aspect 28, wherein the UL-RS transmission is a demodulation reference signal (DMRS) transmission, and wherein the scrambling sequence scrambles the DMRS transmission.

Aspect 34: The method of any of Aspects 20-33, wherein generating the scrambling sequence is further based at least in part on a time of transmission of the L1 uplink transmission.

Aspect 35: The method of any of Aspects 20-34, wherein the downlink transmission is a physical downlink shared channel (PDSCH) transmission, and wherein the PDSCH transmission is selected to generate a scrambling sequence based at least in part one or more selection rules.

Aspect 36: The method of Aspect 35, wherein the one or more selection rules indicate to select the PDSCH transmission based at least in part on the L1 uplink transmission including HARQ feedback for the PDSCH transmission.

Aspect 37: The method of Aspect 35, wherein the one or more selection rules indicate to select the PDSCH transmission based at least in part on previously transmitting an acknowledgment message for the PDSCH transmission.

Aspect 38: The method of Aspect 35, further comprising: transmitting, from the network node, configuration information that indicates the one or more selection rules.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

Aspect 46: A device comprising a processing system that includes one or more processors and one or more code-storing memories coupled with the one or more processors, the processing system configured to cause the device to perform the method of one or more of Aspects 1-38.

Aspect 47: A device comprising a processing system that includes processor circuitry and code-storing memory circuitry, the processing system configured to cause the device to perform the method of one or more of Aspects 1-38.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, a downlink transmission that comprises information;
generate a scrambling sequence to apply to an uplink transmission using the information comprised in the downlink transmission; and
transmit, to the network node, the uplink transmission in accordance with the scrambling sequence.

2. The UE of claim 1, wherein the uplink transmission is an uplink control information (UCI) transmission.

3. The UE of claim 2, wherein the downlink transmission is a physical downlink shared channel (PDSCH) message that was most recently decoded by the UE, and wherein the information used to generate the scrambling sequence is a portion of a payload of the PDSCH message before decryption of the PDSCH message or after decryption of the PDSCH message.

4. The UE of claim 2, wherein the UCI transmission is an aperiodic UCI transmission and the downlink transmission is a downlink control information (DCI) transmission that schedules the aperiodic UCI transmission, and wherein the scrambling sequence is a function of one or more of a payload of the DCI transmission or a CRC of the DCI transmission.

5. The UE of claim 4, wherein the aperiodic UCI transmission includes at least a portion of the payload of the DCI transmission.

6. The UE of claim 2, wherein the scrambling sequence scrambles the UCI transmission before the UCI transmission is encoded.

7. The UE of claim 2, wherein the scrambling sequence scrambles the UCI transmission after the UCI transmission is encoded.

8. The UE of claim 2, wherein the scrambling sequence scrambles a demodulation reference signal sequence of the UCI transmission.

9. The UE of claim 1, wherein the uplink transmission is an uplink reference signal (UL-RS) transmission.

10. The UE of claim 9, wherein the downlink transmission is a physical downlink shared channel (PDSCH) message that was most recently decoded by the UE, and wherein the information used to generate the scrambling sequence is a portion of a payload of the PDSCH message before decryption of the PDSCH message or after decryption of the PDSCH message.

11. The UE of claim 9, wherein the UL-RS transmission is an aperiodic UL-RS transmission and the downlink transmission is a downlink control information (DCI) transmission that schedules the aperiodic UL-RS transmission, and wherein the scrambling sequence is a function of one or more of a payload of the DCI transmission or a CRC of the DCI transmission.

12. The UE of claim 9, wherein the UL-RS transmission is a sounding reference signal (SRS), and wherein the scrambling sequence is used to select the SRS from a set of SRSs.

13. The UE of claim 9, wherein the UL-RS transmission is a sounding reference signal (SRS), and wherein the scrambling sequence scrambles the SRS.

14. The UE of claim 9, wherein the UL-RS transmission is a demodulation reference signal (DMRS) transmission, and wherein the scrambling sequence scrambles the DMRS transmission.

15. The UE of claim 1, wherein generating the scrambling sequence is further based at least in part on a time of transmission of the uplink transmission.

16. The UE of claim 1, wherein the downlink transmission is a physical downlink shared channel (PDSCH) transmission, and wherein the PDSCH transmission is selected to generate the scrambling sequence based at least in part on one or more selection rules.

17. The UE of claim 16, wherein the one or more selection rules indicate to select the PDSCH transmission based at least in part on the uplink transmission including hybrid automatic repeat request feedback for the PDSCH transmission.

18. The UE of claim 16, wherein the one or more processors are further configured to cause the UE to:
receive, from the network node, configuration information that indicates the one or more selection rules.

19. A method of wireless communication performed by a user equipment (UE), comprising:
receiving, from a network node, a downlink transmission that comprises information;
generating a scrambling sequence to apply to an uplink transmission using the information comprised in the downlink transmission; and
transmitting, to the network node, the uplink transmission in accordance with the scrambling sequence.

20. An apparatus for wireless communication, comprising:
means for receiving, from a network node, a downlink transmission that comprises information;
means for generating a scrambling sequence to apply to an uplink transmission using the information comprised in the downlink transmission; and
means for transmitting, to the network node, the uplink transmission in accordance with the scrambling sequence.
